(19) United States
(12) Patent Application Publication
(10) Pub. No.: US 2026/0267933 A1
(43) Pub. Date: Sep. 10, 2026

(54) ELEMENT DRAWING METHOD AND APPARATUS, DEVICE, AND STORAGE MEDIUM

(71) Applicant: DOUYIN VISION CO., LTD., Beijing (CN)

(72) Inventor: Xiangdong LIU, Beijing (CN)

(21) Appl. No.: 18/873,637

(22) PCT Filed: Aug. 4, 2023
(86) PCT No.: PCT/CN2023/111275

§ 371 Date: Dec. 10, 2024

(30) Foreign Application Priority Data
Aug. 5, 2022 (CN) 202210944176.7

(51) Int. Cl. G06F 16/954

(52) U.S. Cl. CPC G06F 16/954

(57) ABSTRACT

An element drawing method and apparatus, a device, and a storage medium. The method includes: obtaining an element configuration file corresponding to a first container, where the first container is used to carry an element on a page corresponding to the first container, the element configuration file is used to store level information and order information of the element in the first container; determining an element drawing sequence corresponding to the first container based on the level information and the order information of the element stored in the element configuration file; and drawing the element on the page corresponding to the first container based on the element drawing sequence corresponding to the first container.

### CROSS-REFERENCE TO RELATED APPLICATIONS

This application claims priority to Chinese Patent Application No. 202210944176.7, filed on Aug. 5, 2022, which is incorporated herein by reference in its entirety as a part of the present application.

### TECHNICAL FIELD

Embodiments of the present disclosure relate to an element drawing method and apparatus, a device, and a storage medium.

### BACKGROUND

Elements on a web page may be respectively arranged in different levels based on level sequences. For example, an element A and an element B belong to different levels. It is assumed that the element A belongs to a level 1, and the element B belong to a level 2.

Currently, a level is created in a manner of wrapping the elements by using a container, and a drawing order of an element in the level is defined by a layout file. In other words, one container is used to implement one level, and elements in different levels exist in different containers.

Because elements in different levels exist in different containers, it is difficult to implement a dependency relationship between the elements in different levels, and it is difficult to main the dependency relationship subsequently.

### SUMMARY

In order to solve the above technical problems, embodiments of the present disclosure provide an element drawing method.

In a first aspect, the present disclosure provides an element drawing method, including:
obtaining an element configuration file corresponding to a first container, where the first container is used to carry an element on a page corresponding to the first container, the element configuration file is used to store level information and intra-level order information of the element in the first container, the level information is used to represent a drawing level of the element in the first container, and the intra-level order information is used to represent drawing order information of the element in the drawing level;
determining an element drawing sequence corresponding to the first container based on the level information and the intra-level order information of the element stored in the element configuration file; and
drawing the element on the page corresponding to the first container based on the element drawing sequence corresponding to the first container.

In an optional embodiment, before the obtaining an element configuration file corresponding to a first container, the method further includes:
determining updated level information and/or updated intra-level order information corresponding to a target element when an update is detected in level information and/or intra-level order information of the target element in the element configuration file corresponding to the first container; and
updating a drawing order of the target element in the element drawing sequence corresponding to the first container based on the updated level information and/or the updated intra-level order information corresponding to the target element.

In an optional embodiment, before the obtaining an element configuration file corresponding to a first container, the method further includes:
in response to an add operation for a first element in the first container, obtaining level information and intra-level order information of the first element from the element configuration file corresponding to the first container; and
determining a drawing order of the first element in the element drawing sequence corresponding to the first container based on the level information and the intra-level order information of the first element.

In an optional embodiment, before the obtaining an element configuration file corresponding to a first container, the method further includes:
in response to a delete operation for a second element in the first container, determining a position of the second element in the element drawing sequence corresponding to the first container based on level information and intra-level order information of the second element; and
deleting the second element at the position in the element drawing sequence corresponding to the first container.

In an optional embodiment, the determining an element drawing sequence corresponding to the first container based on the level information and the intra-level order information of the element in the first container includes:
dividing the element in the first container into element sets corresponding to different levels based on the level information of the element in the first container;
determining an element drawing sequence corresponding to each element set based on intra-level order information of an element in a same element set; and
determining the element drawing sequence corresponding to the first element based on the level information corresponding to each element set and the element drawing sequence corresponding to each element set.

In a second aspect, the present disclosure provides an element drawing apparatus, including: a first obtaining module, configured to obtain an element configuration file corresponding to a first container, where the first container is used to carry an element on a page corresponding to the first container, the element configuration file is used to store level information and intra-level order information of the element in the first container, the level information is used to represent a drawing level of the element in the first container, and the intra-level order information is used to represent drawing order information of the element in the drawing level;
a first determining module, configured to determine an element drawing sequence corresponding to the first container based on the level information and the intra-level order information of the element stored in the element configuration file; and
a drawing module, configured to draw the element on the page corresponding to the first container based on the element drawing sequence corresponding to the first container.

In an optional embodiment, the apparatus according further includes:
a second determining module, configured to determine updated level information and/or updated intra-level order information corresponding to a target element when an update is detected in level information and/or intra-level order information of the target element in the element configuration file corresponding to the first container; and
an update module, configured to update a drawing order of the target element in the element drawing sequence corresponding to the first container based on the updated level information and/or the updated intra-level order information corresponding to the target element.

In a third aspect, the present disclosure provides a computer-readable storage medium, where the computer-readable storage medium stores instructions, and when the instructions are run on a terminal device, the terminal device is enabled to implement the foregoing method.

In a fourth aspect, the present disclosure provides an element drawing device, including: a memory, a processor, and a computer program that is stored in the memory and that can be run on the processor, where when the processor executes the computer program, the foregoing method is implemented.

In a fourth aspect, the present disclosure provides a computer program product, including a computer program/instruction, where when the computer program/instruction is executed by a processor, the foregoing method is implemented.

### BRIEF DESCRIPTION OF DRAWINGS

The accompanying drawings herein are incorporated into this specification and constitute a part of this specification, illustrating embodiments that comply with the present disclosure, and used together with the specification to explain principles of the present disclosure.

To describe embodiments of the present disclosure more clearly, the following briefly describes the accompanying drawings that need to be used in embodiments. Apparently, those of ordinary skill in the art may still derive other drawings from these accompanying drawings without creative efforts.

FIG. 1 is a flowchart of an element drawing method according to an embodiment of the present disclosure;

FIG. 2 is a schematic structural diagram of an element drawing apparatus according to an embodiment of the present disclosure; and

FIG. 3 is a schematic structural diagram of an element drawing device according to an embodiment of the present disclosure.

### DETAILED DESCRIPTION

In order to understand the foregoing objectives, features, and advantages of the present disclosure more clearly, the following further describes the solutions of the present disclosure. It should be noted that, if there is no conflict, embodiments and features in the embodiments of the present disclosure may be combined with each other.

Many specific details are described in the following descriptions to fully understand the present disclosure, but the present disclosure may also be implemented in another manner different from the manner described herein. Apparently, the embodiments in this specification are merely some embodiments of the present disclosure, but not all the embodiments.

Currently, for a layout manner of elements on a page, a level is created in a manner of wrapping elements by using a container, and a drawing order of an element in the level is defined by using a layout file. Because different levels correspond to different containers, that is, elements in different levels belong to different containers, it is difficult to implement a dependency relationship between elements in different levels, and it is difficult to main the dependency relationship subsequently.

Therefore, embodiments of the present disclosure provide an element drawing method. First, an element configuration file corresponding to a first container is obtained, where the first container is used to carry an element on a page corresponding to the first container, the element configuration file stores level information and intra-level order information of the element in the first container, the level information is used to represent a drawing level of the element in the first container, and the intra-level order information is used to represent drawing order information of the element in the drawing level. Then, an element drawing sequence corresponding to the first container is determined based on the level information and the intra-level order information of the element stored in the element configuration file, to further draw the element on the page corresponding to the first container based on the element drawing sequence. In view of this, in embodiments of the present disclosure, a level layout of elements is implemented in a manner of setting, in the element configuration file, level information and intra-level order information for the elements in a same container. Because elements in different levels belong to a same container, it is less difficult to implement a dependency relationship between elements in different levels on the page, and it is convenient for subsequent maintenance.

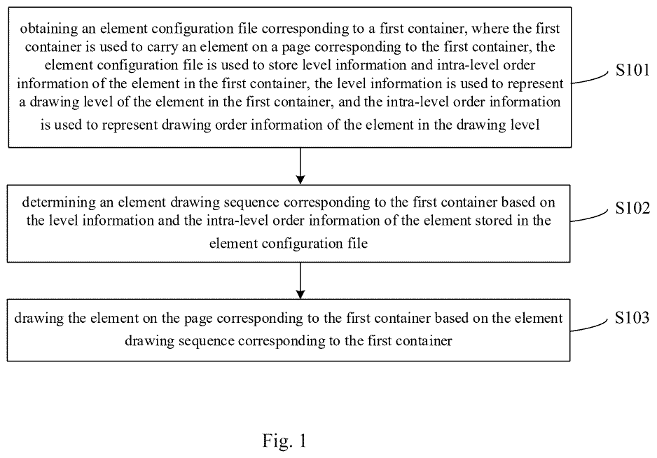

Based on this, an embodiment of the present disclosure provides an element drawing method. FIG. 1 is a flowchart of an element drawing method according to an embodiment of the present disclosure. The method includes:

S101: obtaining an element configuration file corresponding to a first container.

Where, the first container is used to carry an element on a page corresponding to the first container, the element configuration file is used to store level information and intra-level order information of the element in the first container, the level information is used to represent a drawing level of the element in the first container, and the intra-level order information is used to represent drawing order information of the element in the drawing level.

The container is used to carry elements on a web page. Elements on the web page may include various components displayed on the web page, for example, a button component and a list component.

In this embodiment of the present disclosure, the first container may be any container. Assuming that the first container is a container corresponding to a first web page, the first container is used to carry each element on the first web page.

In the embodiment of the present disclosure, there is a correspondence between the element configuration file and the first container, and the element configuration file is used to store the level information and the intra-level order information of the element in the first container. The level information is used to represent the drawing level in which the element is located in the first container, and the intra-level order information is used to represent the drawing order information of the element in the drawing level in which the element is located. For example, the intra-level order information may include a drawing order number of the corresponding element in the drawing level in which the element is located. Assuming that the drawing order number is 5, it represents that the element is the fifth element to be drawn in the drawing level in which the element is located. In an optional implementation, the intra-level order information may include drawing order numbers respectively determined for elements in a same drawing level from top to bottom.

The following table 1 shows an element configuration file according to this embodiment of the present disclosure. The element configuration file stores a correspondence between an element identifier, level information, and intra-level order information of each element in the first container, which is used to define the drawing level of each element in the first container and the drawing order information of the element in the drawing level.

TABLE 1

| Element | Level | Intra-level order |
|---|---|---|
| identifier | information | information |
| A | First level | 5 |
| B | Second level | 3 |

Where, the foregoing element configuration file stores level information “first level” of the element A, and intra-level order information “5” of the element A. To be specific, the element A is in the first drawing level in the first container, and is the fifth element to be drawn in the first drawing level. Similarly, the element B is in the second drawing level and is the third element to be drawn in the second drawing level.

In an actual application, at a web page design and development stage, the level information and the intra-level order information of each element on a web page are predetermined, and the level information and the intra-level order information of each element are stored into the element configuration file as an element configuration file of a container corresponding to the web page. In addition, for the element configuration file, the level information, the intra-level order information, and the like of each element in the element configuration file may be adjusted based on a web page design and development requirement. In addition, when an element is added to or removed from the web page, the level information, the intra-level order information, and the like of the corresponding element may also be adaptively added to or removed from the element configuration file. A specific implementation is described subsequently.

S102: determining an element drawing sequence corresponding to the first container based on the level information and the intra-level order information of the element stored in the element configuration file.

Where the element drawing sequence is used to identify a drawing order of each element in the first container.

In this embodiment of the present disclosure, after the level information and the intra-level order information of each element in the first container are obtained from the element configuration file corresponding to the first container, the drawing order of each element in the first container is determined.

In this embodiment of the present disclosure, the drawing order of each element in the first container is determined comprehensively based on two dimensions, namely, the level information and the intra-level order information of the element, where a weight of the level information of the element is far greater than that of the intra-level order information. A range of a drawing order of the element may be determined based on the level information of the element, and a specific drawing order in this range is determined based on the intra-level order information of the element.

In an optional implementation, the element in the first container is first divided into element sets corresponding to different levels based on the level information of the element in the first container. Specifically, elements with same level information are divided into a same element set. For example, elements with level information “first level” are all divided into a same element set.

Then, in a same element set, a drawing order of each element in each element set is determined based on the intra-level order information of each element in the element set, so as to determine an element drawing sequence corresponding to each element set. Specifically, the intra-level order information of the element can represent a drawing order of each element in the drawing level in which the element is located, and an element drawing sequence corresponding to an element set of the drawing level is determined based on the drawing order of each element in the drawing level. For example, for elements whose level information is “first level”, based on the intra-level order information of each element, an element drawing sequence corresponding to the element set of the “first level”, that is, the element drawing sequence of the first level, may be determined.

Further, the element drawing sequence corresponding to the first container is determined based on the level information corresponding to different element sets and the element drawing sequence corresponding to each element set. Specifically, different element sets correspond to different level information, and element drawing sequences corresponding to different element sets are combined based on the level information, to obtain the element drawing sequence corresponding to the first container.

It may be understood that, each element in an element set corresponding to the highest level (assuming the first level) is drawn with a priority over elements in other levels. Therefore, a drawing order of each element in the element set corresponding to the highest level is prior to that of each element in other levels.

In an optional implementation, after the element drawing sequence corresponding to each level is determined, element drawing sequences corresponding to the levels are connected end to end in a top-down order of the levels, to finally determine the element drawing sequence corresponding to the first container. Each element in the first container may be subsequently drawn based on the element drawing sequence, to further draw the web page corresponding to the first container.

S103: drawing the element on the page corresponding to the first container based on the element drawing sequence corresponding to the first container.

In this embodiment of the present disclosure, after the element drawing sequence corresponding to the first container is determined, the elements in the first container may be sequentially drawn based on the element drawing sequence, to obtain the page on which the elements are drawn.

In an optional implementation, the element drawing sequence corresponding to the first container may be predetermined based on the element configuration file corresponding to the first container, so that the elements on the page corresponding to the first element can be drawn directly based on the element drawing sequence corresponding to the first container when a drawing request for the page corresponding to the first container is received.

In another optional implementation, the element configuration file corresponding to the first container may be obtained when the drawing request for the page corresponding to the first container is received, and then the element drawing sequence corresponding to the first container is determined, to further draw the page corresponding to the first container based on the element drawing sequence.

In the element drawing method provided in this embodiment of the present disclosure, first, the element configuration file corresponding to the first container is obtained, where the first container is used to carry an element on the page corresponding to the first container, and the element configuration file stores the level information and the intra-level order information of the element in the first container. The element drawing sequence corresponding to the first container is determined based on the level information and the intra-level order information of the element stored in the element configuration file, to draw the element on the page corresponding to the first container based on the element drawing sequence. In view of this, in the present disclosure, a level layout of the elements is implemented in a manner of setting, in the element configuration file, the level information and the intra-level order information for the elements in the same container. Because the elements in different levels belong to the same container, it is less difficult to implement the dependency relationship between the elements in different levels on the page, and it is convenient for subsequent maintenance in this embodiment of the present disclosure.

In an actual application, a drawing order of each element in the container corresponding to the page may be predetermined before the page is drawn, so that the page can be drawn more efficiently based on the determined drawing order of each element after the page request is received. In the following scenario, the determined drawing order of each element needs to be adaptively adjusted, to draw the page more accurately.

In an application scenario, assuming that a level relationship or an intra-level drawing order of any one or more elements on the web page is adjusted, in this embodiment of the present disclosure, the level information or the intra-level order information for the one or more elements in the element configuration file may be adjusted, and the drawing order of the one or more elements may be recalculated, to update the element drawing sequence corresponding to the first container, so that each element on the web page can be drawn based on the updated element drawing sequence during subsequent web page drawing.

In an actual application, updated level information and/or updated intra-level order information corresponding to a target element are/is determined when an update is detected in level information and/or intra-level order information of the target element in the element configuration file corresponding to the first container. Then, a drawing order of the target element in the element drawing sequence corresponding to the first container is updated based on the updated level information and/or the updated intra-level order information corresponding to the target element.

Assuming that the level information of the element B in the foregoing table 1 is updated from the “second level” to the “first level”, for the element B, the drawing order of the element B is recalculated based on the updated level information “first level” of the element B, and the position of the element B in the element drawing sequence corresponding to the first container is updated based on the calculated drawing order of the element B. The level of each element on the web page can be dynamically adjusted in the foregoing manner.

In another application scenario, there is a requirement for adding or removing an element on the web page. After the element is added or deleted, how to accurately draw each element on the web page is also a problem that can be resolved in this embodiment of the present disclosure. Therefore, after the element is added to the web page, the added element needs to be preconfigured in the element configuration file of the container corresponding to the web page, that is, the level information and the intra-level order information of the added element are stored in the element configuration file.

In an actual application, level information and intra-level order information of the first element are obtained from the element configuration file corresponding to the first container when an add operation for the first element in the first container is received, where the first element may be any element added to the first container. Then, a drawing order of the first element in the element drawing sequence corresponding to the first container is calculated based on the level information and the intra-level order information of the first element. Specifically, a manner of calculating the drawing order of the first element based on the level information and the intra-level order information of the first element may be understood with reference to the foregoing embodiment, and details are not described herein again.

In addition, a position of a second element in the element drawing sequence corresponding to the first container is determined when a deletion operation for the second element in the first container is received, and then the second element at the position in the element drawing sequence corresponding to the first container is deleted, to update the element drawing sequence corresponding to the first container.

Specifically, when the deletion operation for the second element in the first container is received, the level information and the intra-level order information of the second element is first obtained from the element configuration file corresponding to the first container, and then the position of the second element in the element drawing sequence corresponding to the first container is determined based on the level information and the intra-level order information of the second element, to further delete the second element located at the position in the element drawing sequence, so as to update the element drawing sequence corresponding to the first container after the second element is deleted, thereby facilitating drawing the web page corresponding to the first container.

In the element drawing method provided in this embodiment of the present disclosure, a level layout of the elements is implemented in a manner of setting, in the element configuration file, the level information for the elements in the same container. Because the elements in different levels belong to the same container, it is less difficult to implement the dependency relationship between the elements in different levels, and it is convenient for subsequent maintenance in this embodiment of the present disclosure.

Based on this, in this embodiment of the present disclosure, a level, an intra-level drawing order, and the like of an element may be further dynamically adjusted, and when an element is added to or deleted from the web page, the drawing order of each element on the web page can also be accurately determined, to improve accuracy of web page drawing.

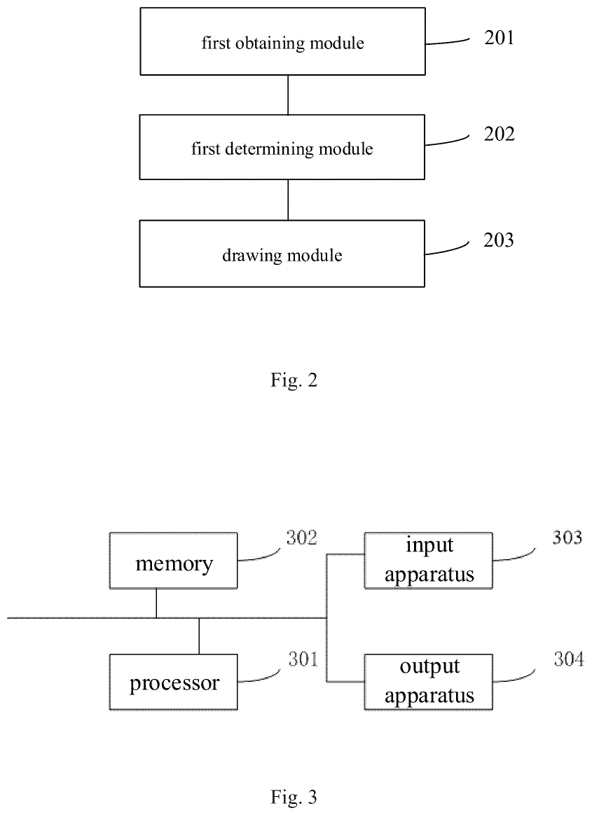

Based on the foregoing method embodiment, the present disclosure further provides an element drawing apparatus. FIG. 2 is a schematic structural diagram of an element drawing apparatus according to an embodiment of the present disclosure. The apparatus includes:
a first obtaining module 201, configured to obtain an element configuration file corresponding to a first container, where the first container is used to carry an element on a page corresponding to the first container, the element configuration file is used to store level information and intra-level order information of the element in the first container, the level information is used to represent a drawing level of the element in the first container, and the intra-level order information is used to represent drawing order information of the element in the drawing level;
a first determining module 202, configured to determine an element drawing sequence corresponding to the first container based on the level information and the intra-level order information of the element stored in the element configuration file; and
a drawing module, configured to draw the element on the page corresponding to the first container based on the element drawing sequence corresponding to the first container.

In an optional implementation, the apparatus further includes:
a second determining module, configured to determine updated level information and/or updated intra-level order information corresponding to a target element when an update is detected in level information and/or intra-level order information of the target element in the element configuration file corresponding to the first container; and
an update module, configured to update a drawing order of the target element in the element drawing sequence corresponding to the first container based on the updated level information and/or the updated intra-level order information corresponding to the target element.

In an optional implementation, the apparatus further includes:
a second obtaining module, configured to: in response to an add operation for a first element in the first container, obtain level information and intra-level order information of the first element from the element configuration file corresponding to the first container; and
a third determining module, configured to determine a drawing order of the first element in the element drawing sequence corresponding to the first container based on the level information and the intra-level order information of the first element.

In an optional implementation, the apparatus further includes:
a fourth determining module, configured to: in response to a delete operation for a second element in the first container, determine a position of the second element in the element drawing sequence corresponding to the first container based on level information and intra-level order information of the second element; and
a deletion module, configured to delete the second element at the position in the element drawing sequence corresponding to the first container.

In a possible implementation, the first determining module includes:
a dividing submodule, configured to divide the element in the first container into element sets corresponding to different levels based on the level information of the element in the first container;
a first determining submodule, configured to determine an element drawing sequence corresponding to each element set based on intra-level order information of an element in a same element set; and
a second determining submodule, configured to determine the element drawing sequence corresponding to the first element based on the level information corresponding to each element set and the element drawing sequence corresponding to each element set.

In the element drawing apparatus provided in this embodiment of the present disclosure, the element configuration file corresponding to the first container is first obtained, where the first container is used to carry an element on the page corresponding to the first container, the element configuration file stores the level information and the intra-level order information of the element in the first container, the level information is used to represent the drawing level at which the element is located in the first container, and the intra-level order information is used to represent the drawing order information of the element in the drawing level. Then, the element drawing sequence corresponding to the first container is determined based on the level information and the intra-level order information of the element stored in the element configuration file, to further draw the element on the page corresponding to the first container based on the element drawing sequence. In view of this, in this embodiment of the present disclosure, a level layout of the elements is implemented in a manner of setting, in the element configuration file, the level information and the intra-level order information for the elements in the same container. Because the elements in different levels belong to the same container, it is less difficult to implement the dependency relationship between the elements in different levels on the page, and it is convenient for subsequent maintenance in this embodiment of the present disclosure.

In addition to the foregoing method and apparatus, an embodiment of the present disclosure further provides a computer-readable storage medium. The computer-readable storage medium stores instructions. When the instructions are run on a terminal device, the terminal device is enabled to perform the foregoing element drawing method in embodiments of the present disclosure.

An embodiment of the present disclosure further provides a computer program product, including a computer program/instruction, where when the computer program/instruction is executed by a processor, the element drawing method in embodiments of the present disclosure is implemented.

In addition, an embodiment of the present disclosure further provides an element drawing device. With reference to FIG. 3, the element drawing device may include:
a processor 301, a memory 302, an input apparatus 303, and an output apparatus 304. There may be one or more processors 301 in the element drawing device. For example, there is one processor 301 in FIG. 3. In some embodiments of the present disclosure, the processor 301, the memory 302, the input apparatus 303, and the output apparatus 304 may be connected by using a bus or in other manners, with an example of bus connection shown in FIG. 3.

The memory 302 may be configured to store software programs and modules. The processor 301 executes various functional applications and data processing of the element drawing device by running the software programs and the modules stored in the memory 302. The memory 302 may mainly include a program storage area and a data storage area, where the program storage area may store an operating system, an application required by at least one function, and the like. In addition, the memory 302 may include a high-speed random access memory, and may further include a non-volatile memory such as at least one magnetic disk storage component, a flash memory, or another volatile solid-state storage component. The input apparatus 303 may be configured to: receive input numeric or character information, and generate a signal input related to user settings and function control of the element drawing device.

Specifically, in this embodiment, the processor 301 loads, according to the following instruction, executable files corresponding to processes of one or more applications, into the memory 302, and the processor 301 runs the applications stored in the memory 302, to implement various functions of the element drawing device.

It should be noted that, in this specification, relational terms such as “first” and “second” are used only to distinguish one entity or operation from another, and do not necessarily require or imply the existence of any such actual relationship or order between those entities or operations. In addition, the terms “include”, “comprise” or any other variant thereof are intended to cover non-exclusive inclusion, so that a process, method, article or device including a series of elements includes not only those elements, but also other elements that are not expressly listed, or that are inherent to such a process, method, article or device. Without further limitation, an element defined by the statement “includes a . . . ” does not exclude the existence of another same element in the process, method, article or device in which the element is included.

The foregoing are merely specific implementations of the present disclosure to enable a person skilled in the art to understand or implement the present disclosure. Various modifications to these embodiments will be apparent to a person skilled in the art, and the general principles defined herein can be realized in other embodiments without departing from the spirit or scope of the present disclosure Therefore, the present disclosure will not be limited to these embodiments herein, but will be subject to the broadest scope consistent with the principles and novel features disclosed herein.

1. An element drawing method, comprising:
obtaining an element configuration file corresponding to a first container, wherein the first container is used to carry an element on a page corresponding to the first container, the element configuration file is used to store level information and order information of the element in the first container, the level information is used to represent a drawing level of the element in the first container, and the information is used to represent drawing order information of the element in the drawing level;
determining an element drawing sequence corresponding to the first container based on the level information and the order information of the element stored in the element configuration file; and
drawing the element on the page corresponding to the first container based on the element drawing sequence corresponding to the first container.

2. The method according to claim 1, wherein before the obtaining an element configuration file corresponding to a first container, the method further comprises:
determining updated level information and/or updated order information corresponding to a target element when an update is detected in level information and/or order information of the target element in the element configuration file corresponding to the first container; and
updating a drawing order of the target element in the element drawing sequence corresponding to the first container based on the updated level information and/or the updated order information corresponding to the target element.

3. The method according to claim 1, wherein before the obtaining an element configuration file corresponding to a first container, the method further comprises:
in response to an add operation for a first element in the first container, obtaining level information and order information of the first element from the element configuration file corresponding to the first container; and
determining a drawing order of the first element in the element drawing sequence corresponding to the first container based on the level information and the order information of the first element.

4. The method according to claim 1, wherein before the obtaining an element configuration file corresponding to a first container, the method further comprises:
in response to a delete operation for a second element in the first container, determining a position of the second element in the element drawing sequence corresponding to the first container based on level information and order information of the second element; and
deleting the second element at the position in the element drawing sequence corresponding to the first container.

5. The method according to claim 1, wherein the determining an element drawing sequence corresponding to the first container based on the level information and the order information of the element in the first container comprises:
dividing the element in the first container into element sets corresponding to different levels based on the level information of the element in the first container;
determining an element drawing sequence corresponding to each element set based on order information of an element in a same element set; and
determining the element drawing sequence corresponding to the first element based on the level information corresponding to each element set and the element drawing sequence corresponding to each element set.

6. (canceled)

7. (canceled)

8. A computer-readable storage medium, wherein the computer-readable storage medium stores instructions, and when the instructions are run on a terminal device, the terminal device is enabled to implement an element drawing method, wherein the element drawing method comprises:
obtaining an element configuration file corresponding to a first container, wherein the first container is used to carry an element on a page corresponding to the first container, the element configuration file is used to store level information and order information of the element in the first container, the level information is used to represent a drawing level of the element in the first container, and the order information is used to represent drawing order information of the element in the drawing level;
determining an element drawing sequence corresponding to the first container based on the level information and the order information of the element stored in the element configuration file; and
drawing the element on the page corresponding to the first container based on the element drawing sequence corresponding to the first container.

9. An element drawing device, comprising: a memory, a processor, and a computer program that is stored in the memory and that can be run on the processor, wherein when the processor executes the computer program, an element drawing method is implemented, wherein the element drawing method comprises:
obtaining an element configuration file corresponding to a first container, wherein the first container is used to carry an element on a page corresponding to the first container, the element configuration file is used to store level information and order information of the element in the first container, the level information is used to represent a drawing level of the element in the first container, and the order information is used to represent drawing order information of the element in the drawing level;
determining an element drawing sequence corresponding to the first container based on the level information and the order information of the element stored in the element configuration file; and
drawing the element on the page corresponding to the first container based on the element drawing sequence corresponding to the first container.

10. (canceled)

11. The method according to claim 2, wherein before the obtaining an element configuration file corresponding to a first container, the method further comprises:
in response to an add operation for a first element in the first container, obtaining level information and order information of the first element from the element configuration file corresponding to the first container; and
determining a drawing order of the first element in the element drawing sequence corresponding to the first container based on the level information and the order information of the first element.

12. The method according to claim 2, wherein before the obtaining an element configuration file corresponding to a first container, the method further comprises:
in response to a delete operation for a second element in the first container, determining a position of the second element in the element drawing sequence corresponding to the first container based on level information and order information of the second element; and
deleting the second element at the position in the element drawing sequence corresponding to the first container.

13. The method according to claim 2, wherein the determining an element drawing sequence corresponding to the first container based on the level information and the order information of the element in the first container comprises:
dividing the element in the first container into element sets corresponding to different levels based on the level information of the element in the first container;
determining an element drawing sequence corresponding to each element set based on order information of an element in a same element set; and
determining the element drawing sequence corresponding to the first element based on the level information corresponding to each element set and the element drawing sequence corresponding to each element set.

14. The computer-readable storage medium according to claim 8, wherein before the obtaining an element configuration file corresponding to a first container, the method further comprises:
determining updated level information and/or updated order information corresponding to a target element when an update is detected in level information and/or order information of the target element in the element configuration file corresponding to the first container; and
updating a drawing order of the target element in the element drawing sequence corresponding to the first container based on the updated level information and/or the updated order information corresponding to the target element.

15. The computer-readable storage medium according to claim 8, wherein before the obtaining an element configuration file corresponding to a first container, the method further comprises:
in response to an add operation for a first element in the first container, obtaining level information and order information of the first element from the element configuration file corresponding to the first container; and
determining a drawing order of the first element in the element drawing sequence corresponding to the first container based on the level information and the order information of the first element.

16. The computer-readable storage medium according to claim 8, wherein before the obtaining an element configuration file corresponding to a first container, the method further comprises:
in response to a delete operation for a second element in the first container, determining a position of the second element in the element drawing sequence corresponding to the first container based on level information and order information of the second element; and
deleting the second element at the position in the element drawing sequence corresponding to the first container.

17. The computer-readable storage medium according to claim 8, wherein the determining an element drawing sequence corresponding to the first container based on the level information and the order information of the element in the first container comprises:
dividing the element in the first container into element sets corresponding to different levels based on the level information of the element in the first container;
determining an element drawing sequence corresponding to each element set based on order information of an element in a same element set; and
determining the element drawing sequence corresponding to the first element based on the level information corresponding to each element set and the element drawing sequence corresponding to each element set.

18. The element drawing device according to claim 9, wherein before the obtaining an element configuration file corresponding to a first container, the method further comprises:
determining updated level information and/or updated order information corresponding to a target element when an update is detected in level information and/or order information of the target element in the element configuration file corresponding to the first container; and
updating a drawing order of the target element in the element drawing sequence corresponding to the first container based on the updated level information and/or the updated order information corresponding to the target element.

19. The element drawing device according to claim 9, wherein before the obtaining an element configuration file corresponding to a first container, the method further comprises:
in response to an add operation for a first element in the first container, obtaining level information and order information of the first element from the element configuration file corresponding to the first container; and
determining a drawing order of the first element in the element drawing sequence corresponding to the first container based on the level information and the order information of the first element.

20. The element drawing device according to claim 9, wherein before the obtaining an element configuration file corresponding to a first container, the method further comprises:
in response to a delete operation for a second element in the first container, determining a position of the second element in the element drawing sequence corresponding to the first container based on level information and order information of the second element; and
deleting the second element at the position in the element drawing sequence corresponding to the first container.

21. The element drawing device according to claim 9, wherein the determining an element drawing sequence corresponding to the first container based on the level information and the order information of the element in the first container comprises:
dividing the element in the first container into element sets corresponding to different levels based on the level information of the element in the first container;
determining an element drawing sequence corresponding to each element set based on order information of an element in a same element set; and
determining the element drawing sequence corresponding to the first element based on the level information corresponding to each element set and the element drawing sequence corresponding to each element set.
